(19) United States
(12) Patent Application Publication
(10) Pub. No.: US 2009/0254355 A1
(43) Pub. Date: Oct. 8, 2009

(54) Service Level Agreement-Based Service Monitoring System using Agents

(76) Inventors: Li-Der Chou, Jhongli City (TW); Chien-Chi Chen, Jhongli City (TW)

Correspondence Address: HDLS Patent & Trademark Services, P.O. BOX 220746, CHANTILLY, VA, 20153-0746, US

(21) Appl. No.: 12/060,880

(22) Filed: Apr. 2, 2008

(51) Int. Cl. G06Q 50/00

(52) U.S. Cl. 705/1

(57) ABSTRACT

A service level agreement-based service monitoring system is provided by a service management broker (SMB) for a service provider registering and publishing a web service, and uploading a service level agreement with a service requester to a database. The service management broker respectively has a monitoring broker online mode, a non-monitoring broker online mode and a non-monitoring broker offline mode. The above three modes correspondingly utilize a broker to monitor the quality of a web service, and the above three modes can be respectively provided for the service requester evaluating the quality of the web service and the service provider examining service evaluations, and further for informing the service provider and the service requester for performing an appropriate operation when any one of the service provider and the service requester breaks the service level agreement.

### BACKGROUND OF THE INVENTION

1. Field of the Invention

The present invention relates to a service level agreement-based service monitoring system using brokers, and more specifically, to a service monitoring system for a broker monitoring the quality of a web service, managing a service level agreement (SLA) and performing an appropriate operation when the SLA is violated.

2. Description of the Related Art

In recent years, web services have been widely applied to the transactions of E-commerce via the Internet. Early in the web services technology evolution, the basic architecture of web service is a service oriented architecture (SOA). Main roles using the basic architecture include a service requester, a service provider, and a service agent called universal description discovery and integration (UDDI). The standard technologies of SOA include a simple object access protocol (SOAP), a web service description language (WSDL) and the UDDI. The quality of service (QoS) plays a very important role in Web service, by which a service requester can know the quality of a service provided by a service provider. The service requesters usually only care the QoS, and the service providers usually care about how to satisfy the service requesters. Hence, the service requester and the service provider must use a service level agreement (SLA) to ensure the service requester obtain a satisfied service. The SLA is similar to the agreement of contracting on the civil law, and the SLA must clearly define the service expectation and request, In another word, the SLA must clearly define the service levels.

The SLA is an agreement signed by the telecommunication service providers and their customers to define the expectation and request of the web service. In another word, the SLA must define the service content and the service levels.

However, the conventional SLA monitoring mechanism utilizes a third party monitoring mode, by which the service requester can't examine the monitoring results.

What is need is a service level agreement-based service monitoring system using brokers which can improve the above disadvantages.

### BRIEF SUMMARY

One object of the invention is to provide a service level agreement-based service monitoring system implemented by brokers, by which a service requestor can examine the monitoring results of a web service.

According to the invention, a web service monitoring method implemented by a broker is provided. A broker can monitor the web service with a perspective of a service requestor. So the service requester can know the QoS of the monitored web service via the broker and judge whether the service level agreement is violated. And both the service provider and the service requester will be informed to perform an appropriate operation when the service level agreement is violated.

The invention can save the negotiating time between the service provider and the service requestor for the web services defined in the service level agreement. The service provider can directly upload a negotiated agreement to the service management broker architecture. Thus, the service requester can directly search for the relative service level agreement when he wants to monitor the web service.

According to the invention, a function for the service requestor evaluating the web service is also provided through storing the evaluation data into a database of the service monitoring system. Thus, the present evaluation data will be a part of the history data for a next service requestor when he evaluates the web service.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an architecture view of a service management broker according to the invention;

FIG. 2 is a flowchart of an operation of the monitoring broker online mode;

FIG. 3 is a flowchart of an operation of the non-monitoring broker online mode;

FIG. 4 is a flowchart of an operation of the non-monitoring broker offline mode; and

FIG. 5 is a flowchart of an operation when the service management broker is utilized to evaluate the web service.

### DETAILED DESCRIPTION

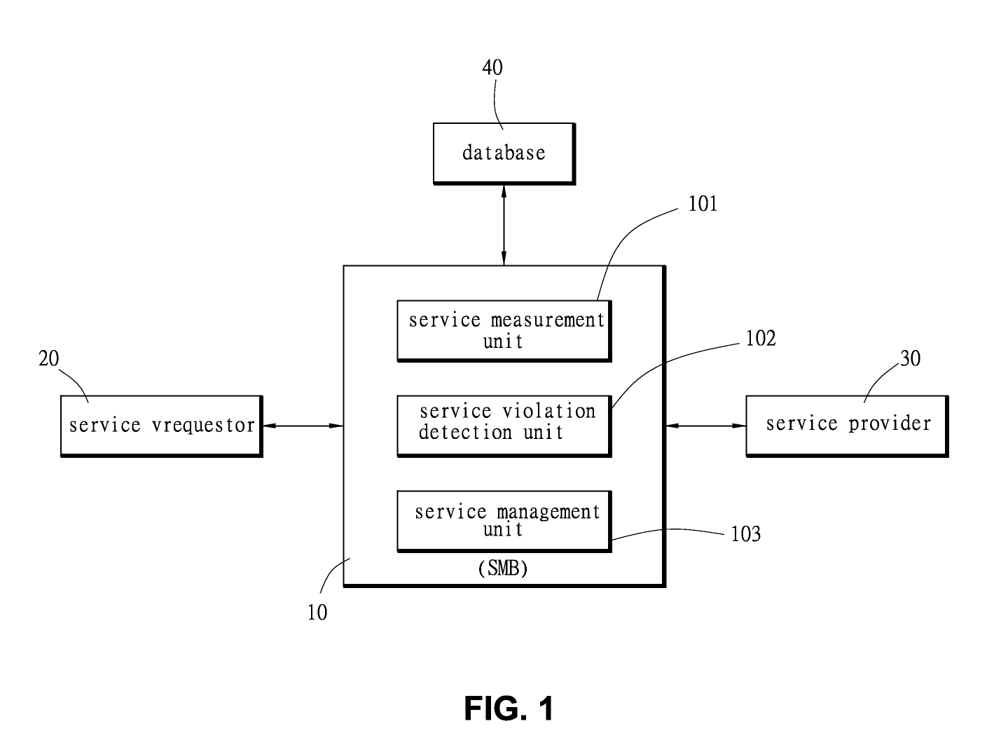

The invention provides a service level agreement-based service monitoring system using brokers. FIG. 1 is an architecture view of a service management broker (SMB) according to the invention. A SMB 10 is provided for a service provider 30 registering, publishing a web service and uploading a service level agreement signed by both a service requestor and the service provider to a database 40. The SMB 10 includes a service measurement unit 101, a service violation detection unit 102 and a service management unit 103.

The service measurement unit 101 measures the QoS of a web service provided by the service provider 30. The service violation detection unit 102 receives the measured QoS and checks whether the service level agreement is violated according to the measured QoS. The service management unit 103 will inform both the service requester 20 and the service provider 30 when the service level agreement is violated. Furthermore, the service requestor can examine the history QoS in the database 40 via the SMB 10.

According to the above architecture, the SMB 10 respectively has a monitoring broker online mode, a non-monitoring broker online mode and a non-monitoring broker offline mode. The monitoring broker online mode utilizes a monitoring broker to monitor the service requester 20 using the web service provided by the service provider 30. The monitoring broker online mode also utilizes the monitoring broker to examine some relative items (such as the service access address, the service evaluation level and the service response action) for the service requester 20. The non-monitoring broker online mode utilizes the SMB 10 to monitor the service requester 20 using the web service provided by the service provider 30. The non-monitoring broker offline mode seasonally monitors the service requestor 20 using the web service provided by the service provider 30.

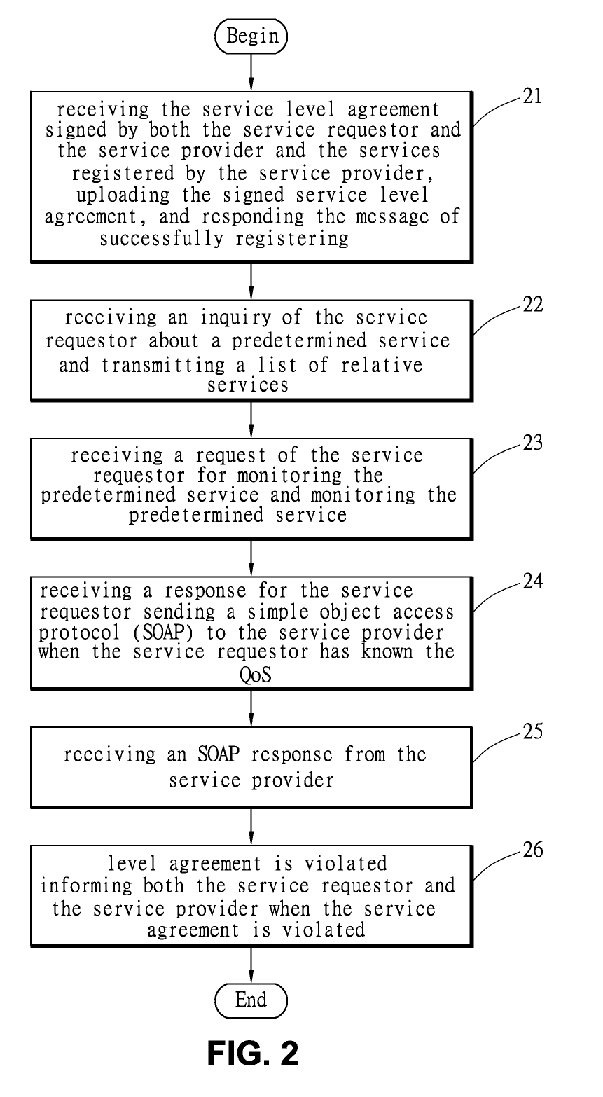

FIG. 2 shows a flowchart of an operation of the monitoring broker online mode when the monitoring broker of the SMB 10 is utilized to monitor the service requester 20 using the web service provided by the service provider 30. The operation of the monitoring broker online mode includes the following steps:

Step 21, receiving the service level agreement signed by both the service requestor 20 and the service provider 30 and the services registered by the service provider 30, uploading the signed service level agreement, and responding the message of successfully registering;

Step 22, receiving an inquiry of the service requestor 20 about a predetermined service and transmitting a list of relative services;

Step 23, receiving a request of the service requestor 20 for monitoring the predetermined service and monitoring the predetermined service;

Step 24, receiving a response for the service requester 20 sending a simple object access protocol (SOAP) to the service provider 30 when the service requestor has known the QoS;

Step 25, receiving an SOAP response from the service provider 30; and

Step 26, informing both the service requestor 20 and the service provider 30 when the service level agreement is violated.

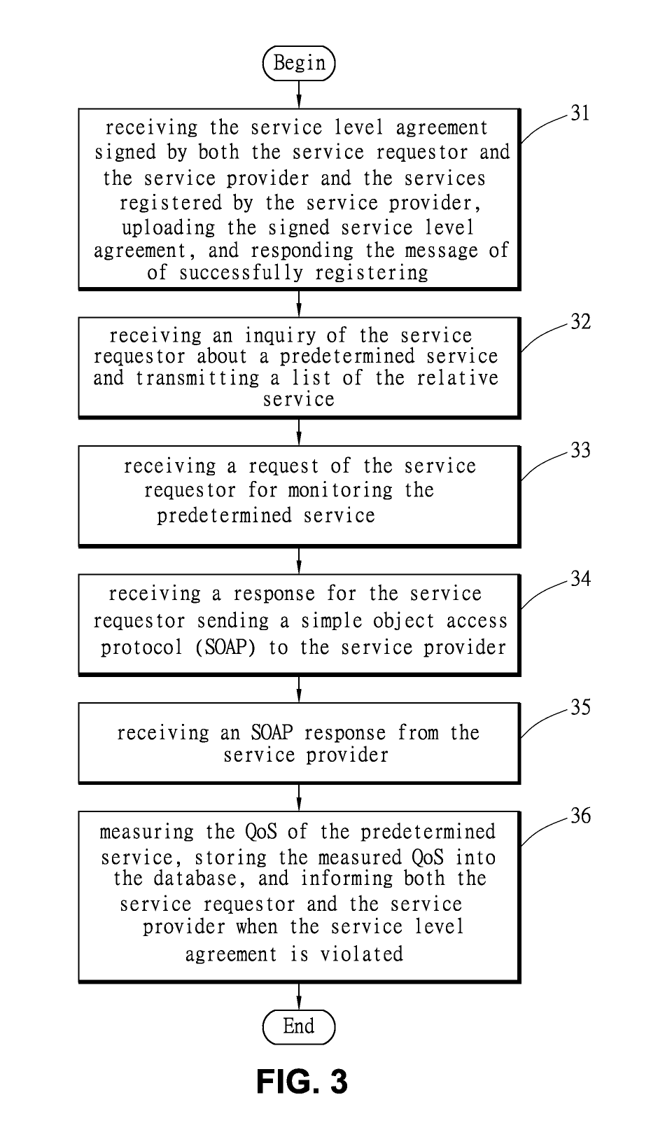

FIG. 3 shows a flowchart of an operation of the non-monitoring broker online mode when the SMB 10 is utilized to monitor the service requestor 20 using the web service provided by the service provider 30. The operation of the non-monitoring broker online mode includes the following steps:

Step 31, receiving the service level agreement signed by both the service requestor 20 and the service provider 30 and the services registered by the service provider 30, uploading the signed service level agreement, and responding the message of successfully registering;

Step 32, receiving an inquiry of the service requestor 20 about a predetermined service and transmitting a list of the relative service;

Step 33, receiving a request of the service requestor 20 for monitoring the predetermined service;

Step 34, receiving a response for the service requester 20 sending a simple object access protocol (SOAP) to the service provider 30.

Step 35, receiving an SOAP response from the service provider 30; and

Step 36, measuring the QoS of the predetermined service, storing the measured QoS into the database 40, and informing both the service requestor 20 and the service provider 30 when the service level agreement is violated.

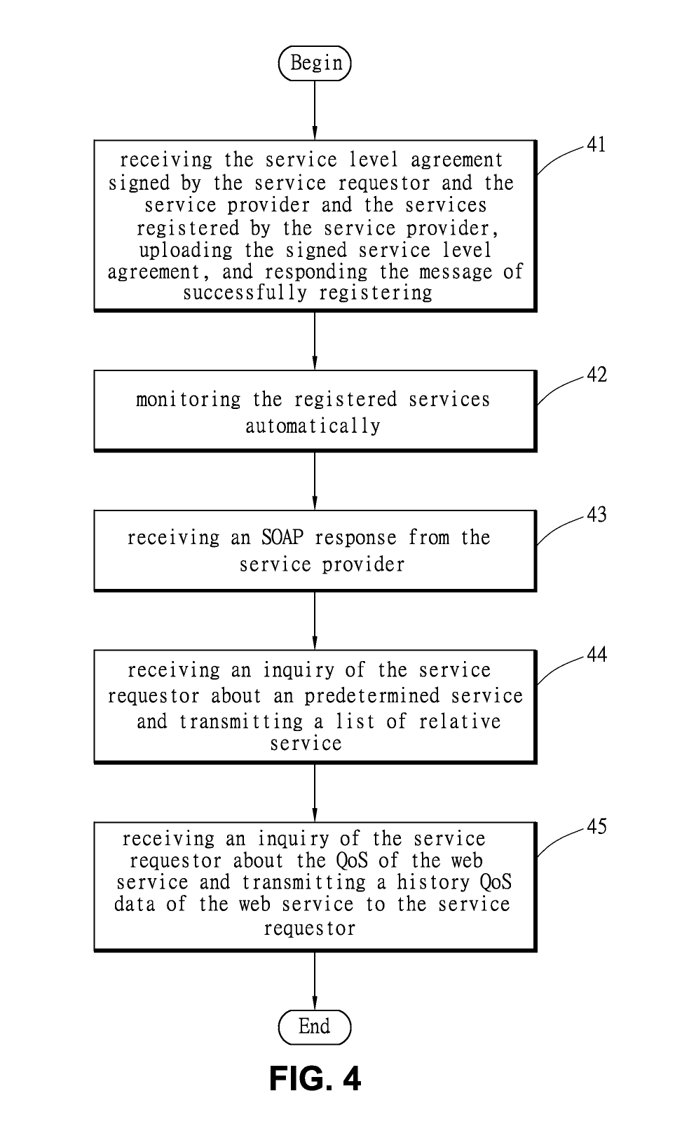

FIG. 4 shows a flowchart of an operation of the non-monitoring broker offline mode when the SMB 10 is utilized to seasonally monitor the registered web services. The operation of the non-monitoring broker offline mode includes the following steps:

Step 41, receiving the service level agreement signed by the service requestor 20 and the service provider 30 and the services registered by the service provider 30, uploading the signed service level agreement, and responding the message of successfully registering;

Step 42, monitoring the registered services automatically;

Step 43, receiving an SOAP response from the service provider 30;

Step 44, receiving an inquiry of the service requestor 20 about an predetermined service and transmitting a list of relative service; and

Step 45, receiving an inquiry of the service requestor 20 about the QoS of the web service and transmitting a history QoS data of the web service to the service requestor 20.

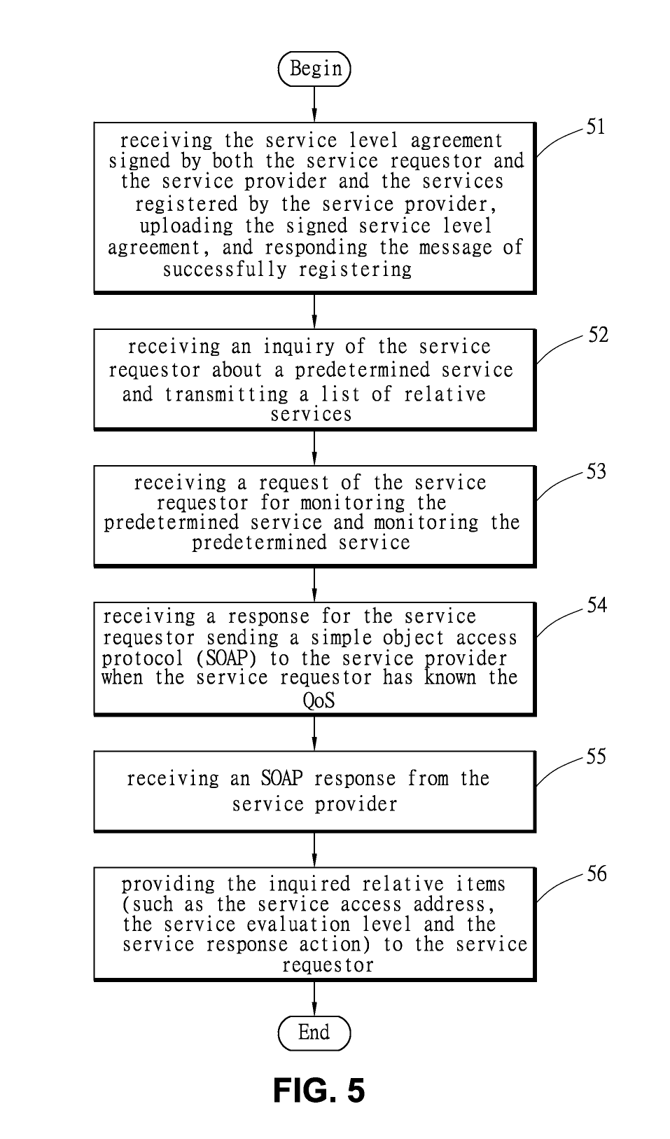

FIG. 5 is a flowchart of an operation when the monitoring broker of the SMB 10 is utilized to monitor the relative items of the web service, such as the service access address, the service evaluation level and the service response action. The operation includes the following steps:

Step 51, receiving the service level agreement signed by the service requestor 20 and the service provider 30 and the services registered by the service provider 30, uploading the signed service level agreement, and responding the message of successfully registering;

Step 52, receiving an inquiry of the service requestor 20 about a predetermined service and transmitting a list of relative services;

Step 53, receiving a request of the service requestor 20 for monitoring the predetermined service and monitoring the predetermined service;

Step 54, receiving a response for the service requester 20 sending a simple object access protocol (SOAP) to the service provider 30 when the service requestor has obtained the QoS;

Step 55, receiving an SOAP response from the service provider 30; and

Step 56, providing the inquired relative items (such as the service access address, the service evaluation level and the service response action) to the service requestor 20.

According to the above, the service monitoring system of the invention can avoid the disadvantage that the service requester 20 can't know the monitoring results on the conventional monitoring mode. With the present invention, the service requestor 20 can know the QoS of the monitored web services and judge whether the service level agreement is violated according to the QoS of the monitored web services. When the service level agreement is violated, both sides of the service level agreement are informed to perform an appropriate operation. The service monitoring system is also provided for the service requestor 20 to examine the relative items. Therefore, the service monitoring system of the invention is of novel, unobvious, and feasible of industrial application.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A service level agreement-based service monitoring system provided by a service management broker (SMB) for a service provider registering and publishing a web service, and uploading a service level agreement signed by both the service provider and a service requestor to a database, the service monitoring system comprising:
a service measurement unit, for measuring the quality of service (QoS) of a web service provided by the service provider;
a service violation detection unit, for obtaining the measured QoS from the service measurement unit and monitoring whether the service level agreement is violated; and
a service management unit, for informing both the service provider and the service requester when the service level agreement is violated.

2. The service monitoring system of claim 1, wherein the service management broker respectively comprises a monitoring broker online mode, a non-monitoring broker online mode and a non-monitoring broker offline mode.

3. The service monitoring system of claim 2, wherein when the monitoring broker of the service management broker is utilized to monitor the service requestor using a web service provided by the service provider, the operation of the monitoring broker online mode comprises:
receiving the service level agreement signed by both the service requestor and the service provider and the services registered by the service provider, uploading the signed service level agreement, and responding the message of successfully registering;
receiving an inquiry of the service requester about a predetermined service and transmitting a list of relative service;
receiving the service requestor's request for monitoring the predetermined service, and monitoring the predetermined service;
receiving a response of the service requester sending a simple object access protocol (SOAP) to the service provider;
receiving a SOAP response from the service provider; and
informing the service requester and the service provider when the service level agreement is violated.

4. The service monitoring system of claim 2, wherein when the service management broker is utilized to monitor the service requestor using a web service provided by the service provider, the operation of the non-monitoring broker online mode comprises:
receiving the service level agreement signed by both the service requestor and the service provider and the services registered by the service provider, uploading the signed service level agreement, and responding the message of successfully registering;
receiving an inquiry of the service requester about a predetermined service and transmitting a list of relative service;
receiving the service requestor's request for monitoring the predetermined service;
receiving a response of the service requester sending an SOAP to the service provider;
receiving a SOAP response from the service provider; and
measuring the QoS of the predetermined service, storing the measured QoS into the database, and informing the service requester and the service provider when the service level agreement is violated.

5. The service monitoring system of claim 2, wherein when the service management broker is utilized to seasonally monitor the registered web services, the operation of the non-monitoring broker offline mode comprises:
receiving the service level agreement signed by the service requestor and the service provider and the services registered by the service provider, uploading the signed service level agreement, and responding the message of successfully registering;
monitoring the registered services automatically;
receiving a SOAP response from the service provider;
receiving an inquiry of the service requester about a predetermined service and transmitting a list of relative service to the service requester; and
receiving an inquiry of the service requestor about the QoS of the web service and transmitting a history data of the web service to the service requestor.

6. The service monitoring system of claim 2, wherein when the monitoring broker is utilized to monitor the relative items of the web service, the operation of the monitoring broker online mode comprises:
receiving the service level agreement signed by both the service requestor and the service provider and the services registered by the service provider, uploading the signed service level agreement, and responding the message of successfully registering;
receiving an inquiry of the service requester about a predetermined service and transmitting a list of the relative service to the service requestor;
receiving a request of the service requestor for monitoring the predetermined service and monitoring the predetermined service;
receiving a response for the service requester sending an SOAP to the service provider;
receiving a SOAP response from the service provider; and
providing the relative items inquired by the service requestor.

7. The service monitoring system of claim 6, wherein the relative items comprises the service access address, the service evaluation level and the service response action.

8. The service monitoring system of claim 1, wherein the service requester receives a history QoS data from the database via the service management broker when the service requester enquiring the QoS of the web service,
